(19) United States
(12) Patent Application Publication
(10) Pub. No.: US 2022/0413137 A1
(43) Pub. Date: Dec. 29, 2022

(54) ULTRASONIC TRANSCEIVER

(71) Applicant: Nippon Ceramic Co., Ltd., Tottori-shi, Tottori (JP)

(72) Inventors: Shuhei TSUNODA, Tottori-shi, Tottori (JP); Kazuya TABUCHI, Tottori-shi, Tottori (JP); Seiya FUKADA, Tottori-shi, Tottori (JP); Makoto SAKAGUCHI, Tottori-shi, Tottori (JP)

(21) Appl. No.: 17/773,513

(22) PCT Filed: Oct. 30, 2020
(86) PCT No.: PCT/JP2020/040808

§ 371 Date: Apr. 29, 2022

(30) Foreign Application Priority Data
Nov. 1, 2019 (JP) 2019-199753

(51) Int. Cl. G01S 15/931

(52) U.S. Cl. CPC G01S 15/931

(57) ABSTRACT

There is provided an ultrasonic sensor including: a closed-bottom tubular case including a bottom portion and a tubular portion; and a piezoelectric element joined to an inner bottom surface of the closed-bottom tubular case. A porous elastic body is in close contact with the inner bottom surface to include a portion at which an amplitude is maximum in the inner bottom surface when transmitting or receiving an ultrasonic wave in the inner bottom surface. An elastic body having a density higher than a density of the porous elastic body is in close contact to an opening side of the closed-bottom tubular case to include a portion at which vibration is transmitted from the inner bottom surface to the tubular portion of the closed-bottom tubular case.

### TECHNICAL FIELD

The present invention relates to an ultrasonic sensor for air in which a piezoelectric element is joined to a closed-bottom tubular case.

### BACKGROUND ART

A safety device that attaches a distance meter unit using an ultrasonic sensor to a vehicle and notifies a driver of a risk of a collision when an object approaches the vehicle is widely used.

In particular, a safety device that detects a rear object by a distance meter unit and notifies a driver of approach of the object is often used when the vehicle is moved backward (Patent Literature 1).

Specifically, a safety device that notifies the driver of the approach of the object with a buzzer or a brake linked safety device that operates the brake so as not to start the vehicle when there is an obstacle in front of the vehicle are disclosed.

In the distance meter unit using the ultrasonic sensor used here, a drip-proof ultrasonic sensor is mainly used.

The drip-proof ultrasonic sensor is introduced, for example, in Patent Literature 2 (in the literature, the drip-proof ultrasonic sensor is referred to as a drip-proof ultrasonic transceiver).

The drip-proof ultrasonic sensor has a structure in which a piezoelectric element having electrodes on both surfaces is bonded to a bottom surface of a closed-bottom tubular case, a terminal electrically connected to each of the electrodes of the piezoelectric element is taken out to an outside, an upper portion of the piezoelectric element is covered with a sponge-like or felt-shaped sound absorbing material, and then sealed with an elastic filler such as silicone rubber.

A back surface on an opening side of the closed-bottom tubular case is completely covered with the filler such as the silicone rubber, whereby a liquid does not enter an inside of the closed-bottom tubular case. Since the electrodes of the piezoelectric element are not short-circuited inside the ultrasonic sensor due to the structure described above, the ultrasonic sensor can be used outdoors where the liquid is applied.

Further, the drip-proof ultrasonic sensor is an ultrasonic sensor having a relatively high strength because the piezoelectric element is covered with a metal case.

### CITATION LIST

### Patent Literature

Patent Literature 1: JP2007-112297A

Patent Literature 2: JP2010-154059A

### SUMMARY OF INVENTION

### Technical Problem

In an ultrasonic sensor of the related art, a sponge molded previously is disposed on an upper side of the piezoelectric element joined to an inner bottom surface of a closed-bottom tubular case, and a sealing material is disposed on an opening side of the closed-bottom tubular case on the sponge.

In this structure, the molded sponge is difficult to insert into a machine with a high accuracy, and requires a manual, costly process.

In the structure of the related art, the molded sponge is in contact with the most part of the inner bottom surface of the closed-bottom tubular case, which is the vibrating surface, and there is a limit to an effect of damping of the inner bottom surffice, making it difficult to shorten the reverberation time which is advantageous for short distance detection.

Further, when the inner bottom surface and the sponge are in contact with each other, when a foreign matter such as a solder ball is caught between the inner bottom surface and the sponge, there is a problem that the foreign matter moves and noise is generated, thereby making an erroneous operation.

### SOLUTION TO PROBLEM:

At a portion at which an amplitude is maximum at a time of transmission and reception of an ultrasonic wave on an inner bottom surface of a closed-bottom tubular case including a bottom portion and a tubular portion,

a porous elastic body, instead of a molded sponge, that does not interfere with vibration of foamed silicone, foamed urethane, or the like that can be filled by coating is disposed,

an elastic body having a vibration damping effect and a density higher than that of the porous elastic body is in close contact with the inner bottom surface at a portion at which vibration is transmitted from the inner bottom surface to the tubular portion of the closed-bottom tubular case, and

reduction of a signal strength of an ultrasonic wave can be prevented while a reverberation time is shortened.

Further, since the porous elastic body and the elastic body are bonded to the inner bottom surface of the closed-bottom tubular case, a foreign matter such as a solder ball is restrained by the porous elastic body and the elastic body, whereby it is possible to prevent a noise voltage caused by movement of the foreign matter.

The porous elastic body can be filled with a stable positional accuracy by using a coating machine capable of controlling a coating position, and it is also possible to provide an ultrasonic sensor having the above-described characteristics and stabilized quality and preventing a manufacturing cost.

### BRIEF DESCRIPTION OF DRAWINGS

Fig. 1 is a cross-sectional view of an ultrasonic sensor according to an embodiment of the present invention.

FIG. 2 is a cross-sectional view of an ultrasonic sensor of the related art.

FIG. 3 is a comparison diagram of a reverberation time, a reflection sensitivity, and a sound pressure of the ultrasonic sensor in the related-art type and the invention type.

### DESCRIPTION OF EMBODIMENTS

### First Embodiment

(Structure of Ultrasonic Sensor of Type of Invention)

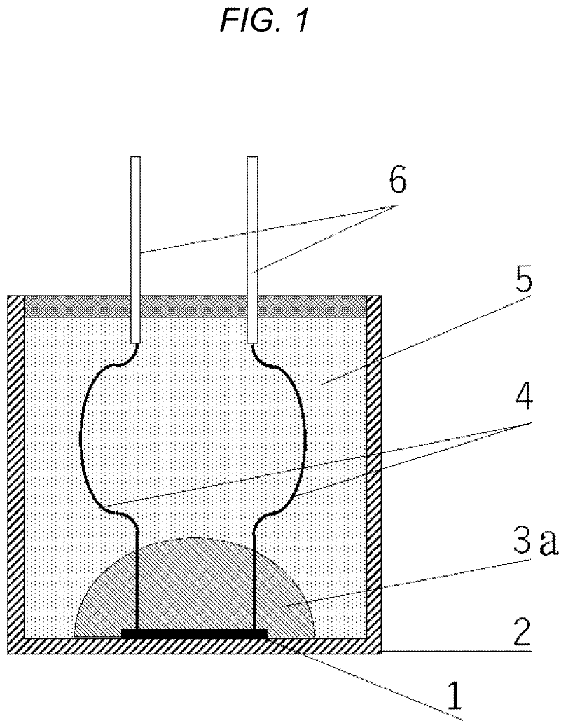

FIG. 1 is a structural diagram of an ultrasonic sensor of the invention type. In a configuration of the ultrasonic sensor of the invention type, a piezoelectric element 1 including a PZT-based ceramic and a folded electrode is bonded to an inner bottom surface of a closed-bottom tubular case 2 formed of an aluminum alloy, a porous elastic body 3a formed of foamed silicone is applied so as to cover a surface or a periphery of a piezoelectric element 1, sealing is performed by filling an elastic body 5 formed of non-porous silicone resin and having a density higher than that of the porous elastic body 3a in a space to which the porous elastic body 3a in the closed-bottom tubular case 2 is not applied, and a lead wire 4 is electrically connected to each of electrodes of the piezoelectric element 1 and each of teiminals of a pin terminal 6 by soldering.

The foamed silicone and the silicone resin are cured by being placed in a room temperature or a high temperature environment after coating or filling. Here, a material of the porous elastic body 3a is not limited to the foamed silicone, and urethane foam or another porous elastic body material may be used, and a material of the elastic body is not limited to the silicone resin, and a urethane resin or another non-porous elastic body material may be used.

In general, when the piezoelectric element 1 is bonded to a portion at which an amplitude is maximum at a time of transmission and reception of an ultrasonic wave at the inner bottom surface of the closed-bottom tubular case 2, since a S/N ratio of the ultrasonic sensor is improved, the application of the porous elastic body 3a is performed so as to cover the surface or the periphery of the piezoelectric element 1, whereas an application range of the porous elastic body 3a is not limited to the surface or the periphery of the piezoelectric element 1, and the porous elastic body 3a may be arranged in a form including a portion at which the amplitude of the inner bottom surface of the closed-bottom tubular case 2 is maximum at the time of the transmission or the reception of the ultrasonic wave.

(Structure of Ultrasonic Sensor of Related-art Type)

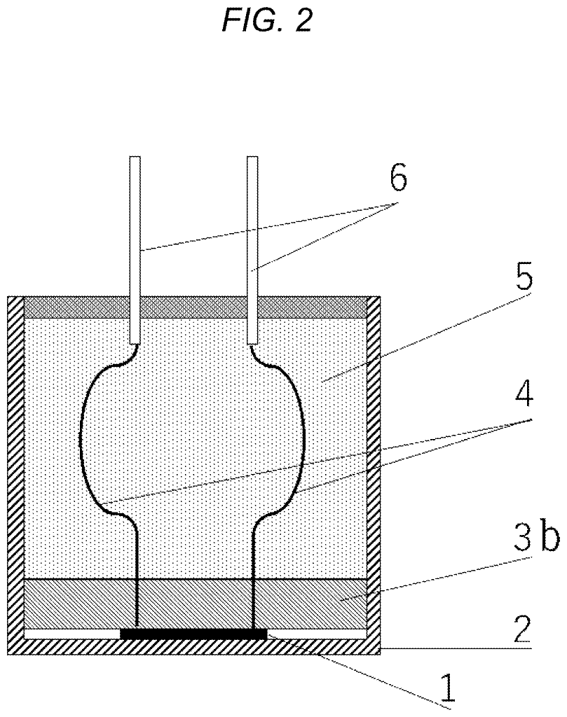

FIG. 2 is an example of a structure diagram of an ultrasonic sensor of related-art type. In a configuration of an ultrasonic sensor of the related-art type, the piezoelectric element 1 including a PZT-based ceramic and a folded electrode is bonded to an inner bottom surface of the closed-bottom tubular case 2 formed of an aluminum alloy, a sponge 3b molded on the piezoelectric element 1 is arranged, the lead wire 4 is electrically connected to each of electrodes on the piezoelectric element 1 and each of terminals of the pin terminal 6 by soldering, and an opening side in the closed-bottom tubular case 2 is sealed by filling an elastic body 3b formed of a non-porous silicone resin.

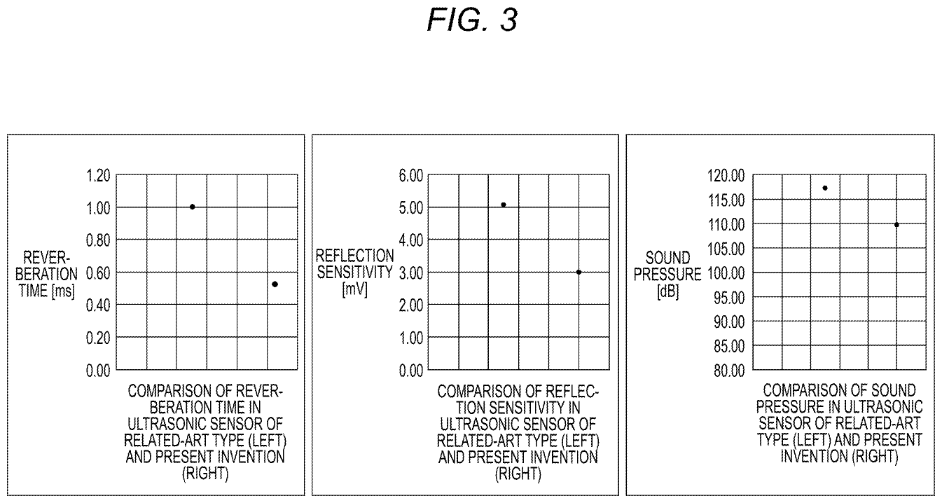

FIG. 3 is a graph showing a reverberation time, a reflection sensitivity, and a sound pressure in the ultrasonic sensor of the invention type of FIG. 1 and the ultrasonic sensor of the related-art type of FIG. 2. The reverberation time is about half that of the related-art type. Meanwhile, the reflection sensitivity and the sound pressure of the related-art type having a low damping effect are higher than those of the invention type.

The invention type has lower values in terms of the reflection sensitivity and the sound pressure than that of the related-art type, and the invention type has sufficient characteristics as an ultrasonic sensor (which is equal to or greater than 1 mV that is actually used as an in-vehicle ultrasonic sensor). A short reverberation means that a short distance object can be detected, and the invention type can be said to be the ultrasonic sensor that is advantageous for the short distance detection.

### INDUSTRIAL APPLICABILITY

The present invention can be applied not only to a vehicle back sensor, a corner sensor, and an automatic parking system but also to various fields in which an ultrasonic sensor is used.

REFERENCE SIGNS LIST

1: piezoelectric element

2: closed-bottom tubular case

3a: porous elastic body

3b: molded sponge

4: lead line

5: elastic body

6: pin terminal

1. An ultrasonic sensor comprising:
a closed-bottom tubular case including a bottom portion and a tubular portion; and
a piezoelectric element joined to an inner bottom surface of the closed-bottom tubular case, wherein
a porous elastic body is in close contact with the inner bottom surface to include a portion at which an amplitude is maximum in the inner bottom surface when transmitting or receiving an ultrasonic wave in the inner bottom surface, and
an elastic body having a density higher than a density of the porous elastic body is in close contact to an opening side of the closed-bottom tubular case to include a portion at which vibration is transmitted from the inner bottom surface to the tubular portion of the closed-bottom tubular case.

2. The ultrasonic sensor according to claim 1, wherein each of the porous elastic body and the elastic body is made of one kind or a plurality of kinds of materials, and is configured by a layer or a plurality of layers.
